(19) United States
(12) Patent Application Publication
(10) Pub. No.: US 2024/0193824 A1
(43) Pub. Date: Jun. 13, 2024

(54) COMPUTING DEVICE AND METHOD FOR REALISTIC VISUALIZATION OF DIGITAL HUMAN

(71) Applicant: ELECTRONICS AND TELECOMMUNICATIONS RESEARCH INSTITUTE, Daejeon (KR)

(72) Inventors: Tae-Joon KIM, Daejeon (KR); Kinam KIM, Daejeon (KR); Seung Uk YOON, Daejeon (KR); Seung Wook LEE, Daejeon (KR); Bon Woo HWANG, Daejeon (KR)

(73) Assignee: ELECTRONICS AND TELECOMMUNICATIONS RESEARCH INSTITUTE, Daejeon (KR)

(21) Appl. No.: 18/472,923

(22) Filed: Sep. 22, 2023

(30) Foreign Application Priority Data
Dec. 9, 2022 (KR) 10-2022-0171109

(51) Int. Cl. G06T 11/00

(52) U.S. Cl. CPC G06T 11/001

(57) ABSTRACT

Disclosed is a method for realistic visualization of a digital human, the method including: setting a specific action of the digital human; determining a scene including the specific action of the digital human and rendering the determined scene to generate a first rendered video; capturing images constituting the first rendered video for each frame to obtain frame data; inputting each piece of the frame data of the first rendered video to two or more realistic visualization modules to obtain frame data of a second rendered video; and combining the frame data of the second rendered video to generate a realistically visualized scene.

### CROSS-REFERENCE TO RELATED APPLICATION

This application claims priority to and the benefit of Korean Patent Application No. 10-2022-0171109, filed in the Korean Intellectual Property Office on Dec. 9, 2022, the entire contents of which are incorporated herein by reference.

### BACKGROUND

### 1. Field of the Invention

The present invention relates to a computing device for realistic visualization of a digital human.

### 2. Discussion of Related Art

Recently, with the development of artificial intelligence (AI) technology, digital humans have been attracting attention, and technologies of representing a digital human in a hyper-realistic manner like a real person have been developed. However, as the quality of realization increases, the resources and time required for processing images increase, imposing limitations in providing a long-term service including a large number of images.

For example, in order to respond to unpredictable situations, such as a digital human mentioning a user's name or reacting based on a user's motion in real time, all processes for image processing need to be performed within an average of 33 ms.

However, the current real-time services have not overcome the above limitations yet, and in order to satisfy time constraints, the expected quality level of image processing results has been significantly lowered.

In addition, allocating more resources for realistic visualization of more sensitive data than other parts, such as faces, is beneficial in obtaining higher quality under limited resources. However, the method also requires additional processes, such as extracting only a specific region or enhancing images by reflecting the result. Therefore, in order to implement the method with real-time service, a special apparatus and method are also required.

### SUMMARY OF THE INVENTION

The present invention is directed to performing real-time realistic visualization using a plurality of visualization modules when performing realistic visualization of a digital human.

In addition, the present invention is directed to, when performing realistic visualization, increasing the average processing speed of the technology by caching duplicate processing.

In addition, the present invention is directed to, when performing realistic visualization, extracting only a specific region of a digital human and intensively processing the region.

The technical objectives of the present invention are not limited to the above, and other objectives may become apparent to those of ordinary skill in the art based on the following descriptions.

According to an embodiment of the present invention, there is disclosed a method for realistic visualization of a digital human, the method including: setting a specific action of the digital human; determining a scene including the specific action of the digital human and rendering the determined scene to generate a first rendered video; capturing images constituting the first rendered video for each frame to obtain frame data; inputting each piece of the frame data of the first rendered video to two or more realistic visualization modules to obtain frame data of a second rendered video; and combining the frame data of the second rendered video to generate a realistically visualized scene.

The determining of the scene may include determining a scene including at least one of a posture of the digital human, a camera, lighting, a background, a viewing angle, a distance, and coordinate information.

The two or more realistic visualization modules may include at least one pair of realistic visualization modules connected in parallel.

Each of the pair of realistic visualization modules connected in parallel may include one or more realistic visualization modules connected thereto in series.

The one or more realistic visualization modules connected in series to each of the pair of realistic visualization modules connected in parallel may be provided in different types.

The method may further include: generating identification information for the realistically visualized scene; and when the identification information for the realistically visualized scene matches identification information for a newly input third rendered video, caching the second rendered video to generate a realistically visualized video.

The identification information may include at least one of scene identification information (scene_ID), action identification information (action_ID), and query identification information (query_id) including the scene identification information and the action identification information.

According to an embodiment of the present invention, there is disclosed a computing device for realistic visualization of a digital human, the computing device including at least one processor configured to perform an operation for realistic visualization of the digital human, wherein the at least one processor may be configured to: set a specific action of the digital human; determine a scene including the specific action of the digital human and render the determined scene to generate a first rendered video; capture images constituting the first rendered video for each frame to obtain frame data; input each piece of the frame data of the first rendered video to two or more realistic visualization modules to obtain frame data of a second rendered video; and combine the frame data of the second rendered video to generate a realistically visualized scene.

The at least one processor may be configured to, when determining the scene, determine a scene including at least one of a posture of the digital human, a camera, lighting, a background, a viewing angle, a distance, and coordinate information.

The at least one processor may be configured to: generate identification information for the realistically visualized scene; and when the identification information for the realistically visualized scene matches identification information for a newly input third rendered video, cache the second rendered video to generate a realistically visualized image.

According to an embodiment of the present invention, there is disclosed a method for realistic visualization of a specific region of a digital human, the method including: determining a scene including a specific action of the digital human and rendering the determined scene to generate a first rendered video; extracting a facial region of the digital human; performing a realistic visualization operation on the facial region using two or more realistic visualization modules connected in parallel to generate frame data of a realistically visualized facial region video; and synthesizing each piece of the frame data of the realistically visualized facial region video and each piece of frame data of the first rendered video.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 illustrates a block diagram of a computing device according to an embodiment of the present invention;

FIG. 2 illustrates a flow chart according to an embodiment of the present invention;

FIG. 3 illustrates an operation and configuration of a computing device according to an embodiment of the present invention; and

FIG. 4 illustrates an operation and configuration of a computing device according to an embodiment of the present invention.

### DETAILED DESCRIPTION OF EXEMPLARY EMBODIMENTS

In the following detailed description, the technology to be described below may have various changes and various embodiments, specific embodiments will be illustrated in the accompanying drawings and described in detail. However, this is not intended to limit the technology described below to specific embodiments, and it should be understood to include all modifications, equivalents, or substitutes included in the spirit and scope of the technology described below.

Terms such as first, second, A, B, and the like may be used to describe various elements, but the elements are not limited by the above terms, and are merely used to distinguish one element from another. For example, without departing from the scope of the technology described below, a first element may be referred to as a second element, and similarly, the second element may be referred to as the first element. Term “and/or” includes any combination of a plurality of related recited items or any of a plurality of related recited items.

In terms used in this specification, singular expressions should be understood to include plural expressions unless clearly interpreted differently in the context, and terms such as “comprising” refer to the described features, numbers, steps, operations, and components, parts or combinations thereof, but it should be understood that it does not exclude the possibility of the presence or addition of one or more other features, numbers, steps, operations, and components, parts or combinations thereof.

Prior to a detailed description of the drawings, it is to be clarified that the classification of components in the present specification is merely a classification for each component responsible for each main function. That is, two or more components to be described below may be combined into one component, or one component may be divided into two or more for each subdivided function. In addition, each component to be described below may additionally perform some or all of the functions of other components in addition to its main function, and some of the main functions of each component may be performed by other components. Of course, some of the main functions of each component may be exclusively performed by other components.

In addition, in performing a method or method of operation, each process constituting the method may occur in a different order from the specified order unless a specific order is clearly described in the context. That is, each process may occur in the same order as specified, may be performed substantially simultaneously, or may be performed in reverse order.

In the following description, realistic visualization is illustrated as being performed by a computing device 100 for realistic visualization. The computing device 100 is a device that consistently processes input data and performs computation required for realistic visualization according to a specific model or algorithm. For example, the computing device may be implemented in the form of a personal computer (PC), a server on a network, a smart device, a chipset in which a design program is embedded, and the like.

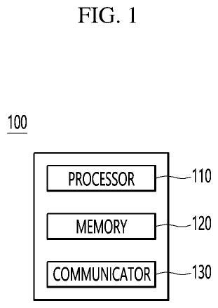

FIG. 1 illustrates a block diagram of a computing device 100 according to an embodiment of the present invention.

In FIG. 1, a block diagram of a computing device for providing realistic visualization of a digital human related to an embodiment of the present disclosure is illustrated. Components of the computing device 100 for providing realistic visualization shown in FIG. 1 are provided for illustrative purposes. Only some of the components shown in FIG. 1 may constitute the computing device 100 for providing realistic visualization, and additional component(s) other than the components shown in FIG. 1 may be included in the computing device 100 for providing realistic visualization.

Referring to FIG. 1, the computing device 100 for providing realistic visualization may include a processor 110, a memory 120, and a communicator 130.

The communicator 130 may transmit and receive data to and from external devices, such as other electronic devices or servers, using wired/wireless communication technology. For example, the communicator 130 may transmit and receive sensor information, a user input, a learning model, a control signal, and the like to and from external devices.

The memory 120 may store data supporting various functions of the computing device 100.

The processor 110 may determine at least one executable operation of the computing device 100. In addition, the processor 110 may control components of the computing device 100 to perform the determined operation.

To this end, the processor 110 may request, retrieve, receive, or utilize data of the memory 120, and control components of the computing device 100 to execute a predicted operation or an operation identified as being desirable among the at least one executable operation.

In this case, the processor 110 may, when there is a need to link with an external device to perform the determined operation, generate a control signal for controlling the external device, and transmit the generated control signal to the external device.

The processor 110 may control at least some components or a combination of components of the computing device 100 to drive an application program stored in the memory 120.

The computing device 100 according to the embodiment of the present invention may transmit and receive data through an interconnection through wireless and/or wired communication. The computing device according to the present disclosure may include any type of computing device capable of computing data in electronic form.

For example, the computing device may be implemented as a fixed device or a movable device, such as a television (TV), a projector, a mobile phone, a smart phone, a desktop computer, a notebook, a digital broadcasting terminal, a personal digital assistant (PDA), a portable multimedia player (PMP), a navigation system, a tablet PC, a wearable device, a set-top box (STB), a Digital Multimedia Broadcasting (DMB) receiver, a radio, a washing machine, a refrigerator, a desktop computer, digital signage, a robot, a vehicle, or the like.

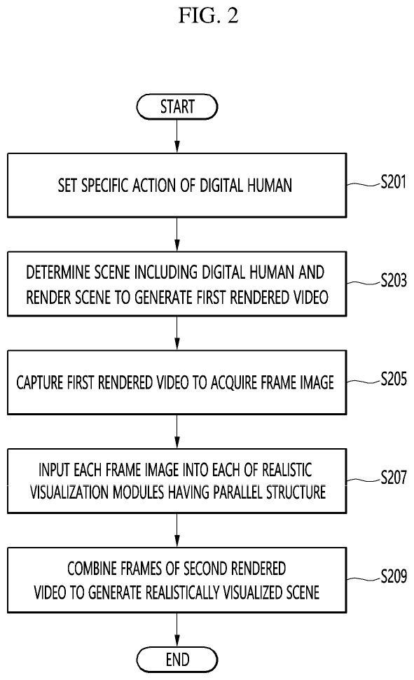

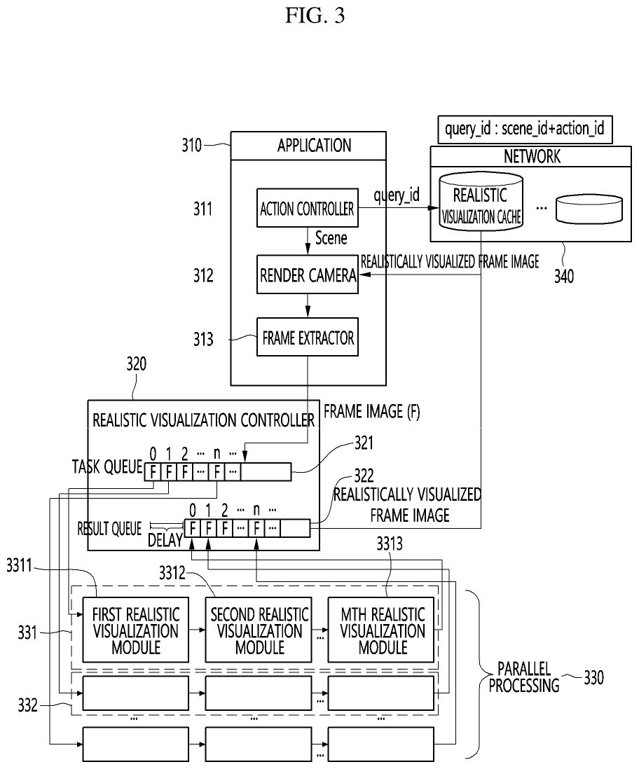

Hereinafter, an operation of the computing device 100 for visualization of a digital human according to an embodiment of the present invention is described with reference to FIGS. 2 and 3.

FIG. 2 illustrates a flow chart according to an embodiment of the present invention, and FIG. 3 illustrates an operation and configuration of a computing device according to an embodiment of the present invention.

First, referring to FIG. 3, the processor 110 of the computing device 100 may control overall operations of an application program 310 for extracting frames from a scene including a digital human, at least one realistic visualizer 330 for performing realistic visualization, and a realistic visualization controller 320 for controlling realistic visualization using a task queue 321 and a result queue 322. The detailed configuration will be described below.

The application program 310 for realistic visualization services according to the embodiment of the present invention may include an action controller 311, a render camera 312, and a frame extractor 313.

First, the action controller 311 may determine a specific action (e.g., greeting, extending a hand, calling a user's name, and the like) of a digital human according to a situation (S201). The digital human may perform the specific action set by the action controller 311.

The render camera 312 may, when a scene including a posture of the digital human in which the specific action is reflected, a camera, lighting, a background, and the like is determined, render the scene (S203).

In this case, rendering may refer to a process of generating a two dimensional (2D) video from a view point of a specific camera using a three dimensional (3D) scene.

In addition, the render camera 312 may, in order to determine the scene including the digital human, set a field of view (FOV), a distance, and coordinate values, and may generate the scene based on the set information.

The existing application program may output the rendered scene generated through the render camera. In the following description, the conventional rendered scene output from the application program is referred to as a “first rendered video.”

The frame extractor 313 according to the embodiment of the present invention may, when the first rendered video is determined, capture the first rendered video generated by the render camera in real time to extract a frame image (S205). In this case, the capture may be performed for each frame of the first rendered video.

According to the embodiment of the present invention, the processor may transmit the extracted frames to the realistic visualization controller 320.

The realistic visualization controller 320 may input each frame of the first rendered video received from the frame extractor 313 to the task queue 321. Specifically, a task queue may refer to a data structure in which the order for performing realistic visualization on each frame of the first rendered video is stored.

The at least one realistic visualizer 330 may perform realistic visualization on each piece of frame data of the first rendered video stored in the task queue 321 (S207).

In this case, the realistic visualizer 330 may include one or more realistic visualization modules. The plurality of realistic visualization modules may be connected in parallel or series to each other. Specifically, each of the frame images of the first rendered video may be input to two or more realistic visualization modules to perform realistic visualization, and the two or more realistic visualization modules may include at least one pair of realistic visualization modules connected in parallel.

For example, referring to FIG. 3, frame data stored in “a task queue 0 based on the first rendered video may be input into a first serial realistic visualization module 331, in which m realistic visualization modules 3311, 3312, 3313, and the like including a first realistic visualization module 3311, a second realistic visualization module 3312 and a third realistic visualization module 3313 are connected in series, to thereby undergo realistic visualization.

In addition, frame data stored in a task queue 1 may be input into a second serial realistic visualization module 332, which is configured in a parallel manner to the serially connected realistic visualization modules, to thereby undergo realistic visualization.

In addition, the first serial realistic visualization module 331 and the second serial realistic visualization module 332 may form a parallel structure.

In addition, the order and type of the realistic visualization modules 3311, 3312, 3313, etc. constituting the first serial realistic visualization module 331 and the second serial realistic visualization module 332 may be the same or different.

Meanwhile, there may be realistic visualization modules forming a plurality of parallel structures, and there may be realistic visualization modules connected in series to each of the realistic visualization modules forming the parallel structures.

The above operation may be repeatedly performed on each piece of frame data stored in the task queue 321. That is, when there are n parallel realistic visualization modules, pieces of frame data allocated to “task queues 0 to n−1 may be input to the n parallel realistic visualization modules, respectively, and frame data allocated to a task queue n may be input to the first realistic visualization module.

As in the above example, the realistic visualizer 330 may perform realistic visualization on each piece of the frame data of the first rendered video sequentially stored in the task queue 321, and sequentially store the results of realistic visualization in the result queue 322.

Hereinafter, a rendered video obtained by performing realistic visualization on each frame of the first rendered video may be referred to as a “second rendered video.”

Meanwhile, the embodiment of the present invention is characterized by the structural arrangement of the realistic visualization modules, and the method for realistic visualization may employ disclosed algorithms or conventional technologies.

The realistic visualization controller 320 may transmit frames of the second rendered video allocated to the result queue 322 to the render camera 312.

The render camera 312 may combine each frame of the second rendered video and output a second rendered video to provide a realistically visualized scene (S209).

With such a configuration, users may experience a realistic digital human.

Meanwhile, the time required for a series of processes according to execution of the realistic visualization of the first rendered video through the realistic visualizer 330 becomes a delay time, and the delay time is based on the processing time of the realistic visualization module.

Specifically, the delay time may refer to a time interval between a time when a specific action is required and a time when the specific action actually starts to be provided.

For example, the delay time may be considered a time difference between when a user appears on a service device and when a digital human starts greeting.

When the processing process of the realistic visualization module included in the realistic visualizer 330 is only one, the delay time may be the same as the frame processing time, and when the time exceeds 33 ms, real-time capability may not be ensured.

However, when the realistic visualization modules 331 and 332 are configured as a parallel structure, and simultaneously processed as in the present invention, the time for generating each frame may be reduced in proportion to the number of parallel modules, and thus real-time capability may be ensured.

Hereinafter, the realistic visualization cache according to the present invention will be described.

During the rendering of the render camera according to the present invention, when a digital human, clothes worn by the digital human, lighting, a background, a camera, and the like, which constitute a scene, are all fixed, it may be expected that each frame image rendered for the same action may be the same.

In other words, when the realistic visualization module is deterministic, that is, when the realistic visualization module always produces the same output for the same input, the realistic visualization result may also be expected to be the same for the same scene and action.

Therefore, instead of performing realistic visualization every time, once a result obtained by realistic visualization has been cached, the cached result may be directly provided to the render camera in response to a request for the same scene and the same action as the cached result, and thus the average processing speed may be increased.

Specifically, a realistic visualization cache 340 may store the previously generated second rendered video in a network or memory.

For example, each scene may be assigned an ID scene_id, and each action may also be assigned an ID action_id, and the combination of the two IDs may be newly defined as a query ID query_id, and whether to use the cache may be determined by the query ID query_id.

Thereafter, when scene identification information scene_id assigned to a digital human, clothes worn by the digital human, lighting, a background, a camera, and the like constituting a scene and action information action_id including motion and posture information of the digital human are the same as those of the second rendered video, the previously stored second rendered video may be cached and transmitted to the render camera 312 to directly generate a realistically visualized image.

The realistic visualization cache 340 may be present in a device such as a device on which the application program runs, or may be present in a server so as to be provided through a network. When a plurality of service devices share a cache server, cache efficiency may be further increased.

Meanwhile, according to an embodiment of the present invention, when a specific part is subject to a higher level of realistic visualization rather than the whole video is subject to realistic visualization with the same quality, higher user satisfaction may be obtained with limited resources and the same time.

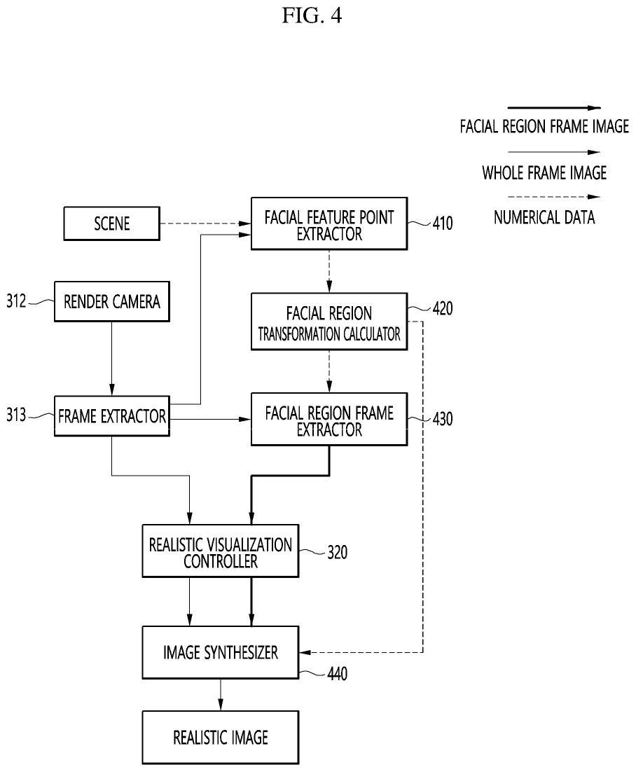

Hereinafter, a computing device for rendering a digital human that provides an improved speed by performing visualization on a specific part of the digital human is described with reference to FIG. 4.

FIG. 4 illustrates an operation and configuration of a computing device according to an embodiment of the present invention.

According to an embodiment of the present invention, the realistic visualizer may include one or more modules that realistically visualize only a specific region of a digital human when rendering the digital human.

In this case, the specific region may correspond to a facial region of the digital human. Meanwhile, according to various embodiments, it is also possible to set a part other than the face as a specific region. In the present invention, for convenience of description, the specific region is illustrated as a facial region.

First, the present invention may further include a facial feature point extractor 410 that detects a facial region and extracts the detected facial region.

The facial feature point extractor 410 may derive facial feature points using frame data of a first rendered video or 3D data of a scene.

Specifically, the facial feature point extractor 410 may, in order to detect the facial region, detect points (both eyes, a nose tip, both ends of lips, and the like), which are considered key features of a face, as facial feature points based on a shape required by a realistic visualization module that targets a face.

When the facial feature point extractor 410 finds facial feature points, a facial region transformation calculator 420 may calculate transformation information for extracting a facial region corresponding to a face from a frame based on the found facial feature points.

The transformation information may refer to information about movement, enlargement/reduction, rotation, and the like of facial feature points.

The facial region transformation calculator 420 may transform the position of the facial region within the frame into specific coordinates using the transformation information on the facial feature points.

A facial region frame extractor 430 may transform all points in the facial region as well as points included in the facial feature region using the transformation information to detect the facial region.

The realistic visualization controller 320 may acquire a first rendered video extracted by the frame extractor 313 and facial region information acquired by the facial region frame extractor 430. Then, as described above, the realistic visualization controller 320 may perform realistic visualization on the facial region information in a parallel manner using the one or more realistic visualization modules included in the realistic visualizer.

An image synthesizer 440 may synthesize each piece of frame data of a realistically visualized facial region video generated according to the realistic visualization of the facial region information with each piece of frame data of the first rendered video rendered through the frame extractor 313, thereby performing facial region realistic visualization. In this case, the generated final realistic visualization image may be a second rendered video.

In this case, for accurate image synthesis, the transformation information derived through the facial region transformation calculator 420 may be inverse-transformed such that the facial region is accurately matched to the first rendered video.

Meanwhile, although it is omitted for the sake of convenience of description, the process of realistic visualization of the facial region should be interpreted as including the operations of FIGS. 2 and 3 without change.

With such a configuration, the present invention performs realistic visualization limited to a specific region, and thus allows the existing realistic visualization technology, which could not have real-time capability, to be applied to provide realistic services that were previously unattainable.

Those skilled in the art should appreciate that the present invention may be embodied by various illustrative logical blocks, modules, processors, means, circuits, and algorithm steps described in connection with the embodiments disclosed herein that may be implemented as electronic hardware, various types of program or design code (for the sake of convenience, referred to as software here), or combinations thereof.

The present invention described above may be embodied as computer-readable code on a medium on which a program is recorded. The computer-readable recording medium is any data storage device that can store data that can thereafter be read by a computer system. Examples of the computer-readable recording medium may include a hard disk drive (HDD), a solid-state drive (SSD), a silicon disk drive (SDD), a read-only memory (ROM), a random-access memory (RAM), a compact disc read only memory (CD-ROM), a magnetic tape, a floppy disk, an optical data storage, or the like.

As is apparent from the above, the present invention can enable realistic visualization of a digital human that responds to changing scenes in real time.

The present invention can maximize quality efficiency per processing time by extracting only a specific region and intensively processing the extracted region when performing a realistic visualization operation on a digital human.

What is claimed is:

1. A method for realistic visualization of a digital human, the method comprising:
setting a specific action of the digital human;
determining a scene including the specific action of the digital human and rendering the determined scene to generate a first rendered video;
capturing images constituting the first rendered video for each frame to obtain frame data;
inputting each piece of the frame data of the first rendered video to two or more realistic visualization modules to obtain frame data of a second rendered video; and
combining the frame data of the second rendered video to generate a realistically visualized scene.

2. The method of claim 1, wherein the determining of the scene includes determining a scene including at least one of a posture of the digital human, a camera, lighting, a background, a viewing angle, a distance, and coordinate information.

3. The method of claim 1, wherein the two or more realistic visualization modules include at least one pair of realistic visualization modules connected in parallel.

4. The method of claim 3, wherein each of the pair of realistic visualization modules connected in parallel includes one or more realistic visualization modules connected thereto in series.

5. The method of claim 4, wherein the one or more realistic visualization modules connected in series to each of the pair of realistic visualization modules connected in parallel are provided in different types.

6. The method of claim 1, further comprising:
generating identification information for the realistically visualized scene; and
when the identification information for the realistically visualized scene matches identification information for a newly input third rendered video, caching the second rendered video to generate a realistically visualized video.

7. The method of claim 6, wherein the identification information includes at least one of scene identification information (scene_ID), action identification information (action_ID), and query identification information (query_id) including the scene identification information and the action identification information.

8. A computing device for realistic visualization of a digital human, the computing device comprising at least one processor configured to perform an operation for realistic visualization of the digital human,
wherein the at least one processor is configured to:
set a specific action of the digital human;
determine a scene including the specific action of the digital human and render the determined scene to generate a first rendered video;
capture images constituting the first rendered video for each frame to obtain frame data;
input each piece of the frame data of the first rendered video to two or more realistic visualization modules to obtain frame data of a second rendered video; and
combine the frame data of the second rendered video to generate a realistically visualized scene.

9. The computing device of claim 8, wherein the at least one processor is configured to, when determining the scene, determine a scene including at least one of a posture of the digital human, a camera, lighting, a background, a viewing angle, a distance, and coordinate information.

10. The computing device of claim 8, wherein the two or more realistic visualization modules include at least one pair of realistic visualization modules connected in parallel.

11. The computing device of claim 10, wherein each of the pair of realistic visualization modules connected in parallel includes one or more realistic visualization modules connected thereto in series.

12. The computing device of claim 11, wherein the one or more realistic visualization modules connected in series to each of the pair of realistic visualization modules connected in parallel are provided in different types.

13. The computing device of claim 8, wherein the at least one processor is configured to:
generate identification information for the realistically visualized scene; and
when the identification information for the realistically visualized scene matches identification information for a newly input third rendered video, cache the second rendered video to generate a realistically visualized image.

14. The computing device of claim 13, wherein the identification information includes at least one of scene identification information (scene_ID), action identification information (action_ID), and query identification information (query_id) including the scene identification information and the action identification information.

15. A method for realistic visualization of a specific region of a digital human, the method comprising:
determining a scene including a specific action of the digital human and rendering the determined scene to generate a first rendered video;
extracting a facial region of the digital human;
performing a realistic visualization operation on the facial region using two or more realistic visualization modules connected in parallel to generate frame data of a realistically visualized facial region video; and
synthesizing each piece of the frame data of the realistically visualized facial region video and each piece of frame data of the first rendered video.
